(19) United States
(12) Patent Application Publication
(10) Pub. No.: US 2007/0279751 A1
(43) Pub. Date: Dec. 6, 2007

(54) Multiple-layer optical film intermediated with corrugated pattern layer and process thereof

(76) Inventor: Ching-Bin Lin, Taipei (TW)

Correspondence Address: Ching-Bin Lin, P.O. Box 55-846, Taipei, 104, omitted

(21) Appl. No.: 11/447,515

(22) Filed: Jun. 5, 2006

(51) Int. Cl. G02B 5/02

(52) U.S. Cl. 359/599; 359/831

(57) ABSTRACT

A multiple-layer optical film comprises: a base layer; a middle alternating protrusion and recess pattern layer formed on the base layer; and an upper prismatic layer formed on the middle pattern layer, thereby forming a multiple-layer optical layer having its optical property and mechanical property simultaneously enhanced as effected by the middle pattern layer as interlocked in between the upper prismatic layer and the base layer.

### BACKGROUND OF THE INVENTION

U.S. Pat. No. 5,635,278 (and its corresponding international application of WO 96/23649) disclosed an optical film having a crosslinkable oligomeric resin composition on the base. Namely, a prismatic microstructure layer (Ms) as illustrated in FIG. 1 is formed on the base layer (Mb) to be an optical film used for backlit display.

However, such a prior art has the following drawbacks:
1. The optical film comprised of the upper structured layer and the base layer will show significant dimensional instability when exposed to temperature fluctuations. The dimensional instability may form wrinkles in the film when thermally expanded or contracted, thereby causing warping, which is a serious defect when used as backlit display.
2. The upper layer (Ms) is made of crosslinkable oligomeric resin composition while the base layer (Mb) is made of polycarbonate (PC) or polyethylene terephthalate (PET). After being used for a long time, the two different layers may no longer be well bonded at the interface (Mi) in between the two layers (Ms, Mb), thereby deteriorating the film quality and influencing its visual effect.
3. No intermediate or middle layer is provided in between the upper layer (Ms) and the base layer (Mb), thereby lacking of mechanism for further enhancing the optical diffusion or other optical properties between the layers.

The present inventor has found the drawbacks of the prior art and invented the present multiple-layer optical film having enhanced mechanical and optical properties.

### SUMMARY OF THE INVENTION

The object of the present invention is to provide a multiple-layer optical film comprising: a base layer; a middle alternating protrusion and recess pattern layer formed on the base layer; and an upper prismatic layer formed on the middle pattern layer, thereby forming a multiple-layer optical layer having its optical property and mechanical property simultaneously enhanced as effected by the middle pattern layer as interlocked in between the upper prismatic layer and base layer.

### BRIEF DESCRIPTION OF THE DRAWINGS

FIG. 1 is a sectional drawing showing a conventional prism sheet of the prior art.

FIG. 2 is a sectional drawing of the base layer of the present invention.

FIG. 3 is a sectional drawing of the present invention having the middle pattern layer formed on the base layer.

FIG. 4 is a sectional drawing of the present invention having three layers integrally formed.

FIG. 5 is a top view of FIG. 3 of the present invention.

FIG. 6 is an illustration showing another preferred embodiment of the present invention as modified from FIGS. 5 and 3.

FIG. 7 is a further preferred embodiment of the present invention.

FIG. 8 shows still another preferred embodiment of the present invention.

FIG. 9 shows the other preferred embodiment.

FIG. 10 shows an embodiment having its middle pattern layer formed as alternating convex and recess portions.

FIG. 11 shows an embodiment having its middle pattern layer formed as alternating protrusion and concave portions.

FIG. 12 shows still further preferred embodiment of the present invention comprised of two layers.

### DETAILED DESCRIPTION

As shown in FIGS. 2˜4, the present invention comprises: a base layer (or supporting layer) 1; a middle alternating protrusion and recess pattern layer (or a middle corrugated layer) 2; and an upper prismatic layer 3.

The base layer 1 may be formed with transparent plastic materials including polycarbonate (PC), polyethylene Terephthalate (PET), etc.

The middle (or intermediate) pattern layer 2 includes alternating protrusions 21 and recesses 22 alternately formed on the base layer 1.

The middle pattern layer 2 may be made of photo-curing resins (including UV-curing resin, acrylic resin, etc.) and thermosetting (or heat-curing) resins.

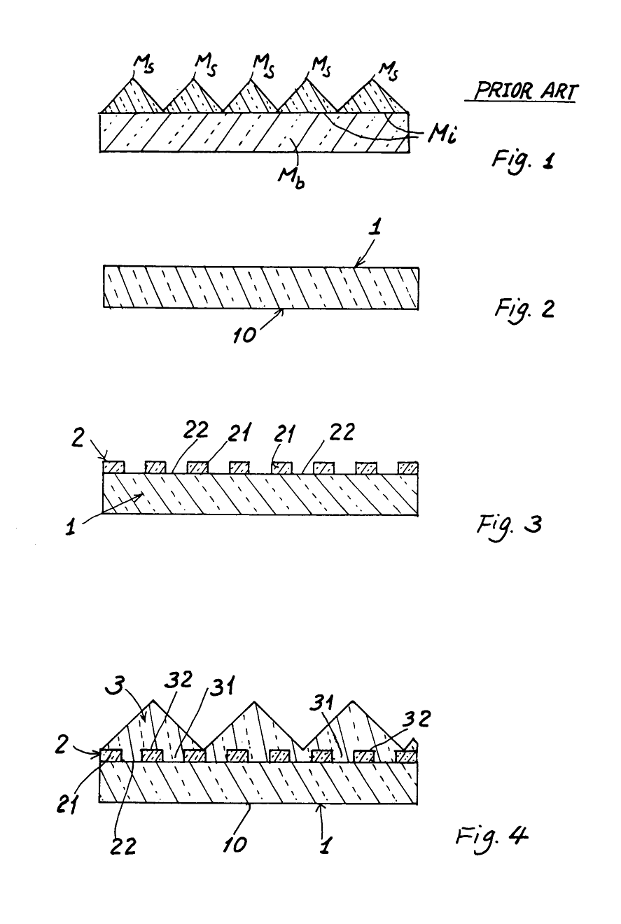

The middle pattern layer 2 may be formed as alternating protrusions 21 and recesses 22, each protrusion 21 formed as a linear strip having a cross section of rectangular shape and each recess 22 formed as a linear groove having a cross section of rectangular shape, as shown in FIGS. 3 and 5.

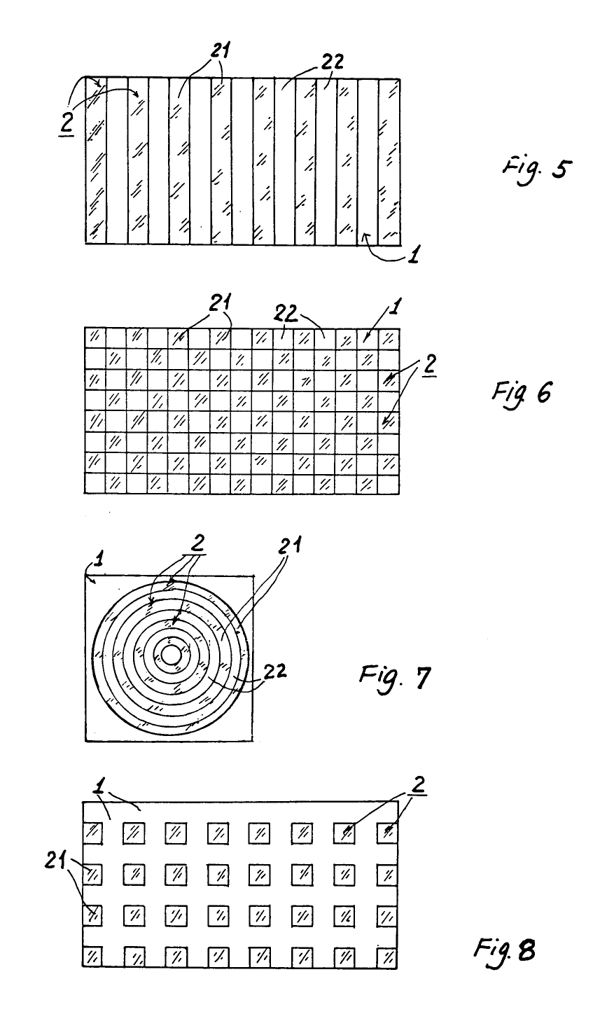

As shown in FIG. 6, the alternating protrusion and recess pattern layer 2 has been modified to include a plurality of square protrusions 21 and recesses 22 alternately formed on the base layer 1.

As shown in FIG. 7, a plurality of annular protrusions 21 and recesses 22 are concentrically and alternately formed on the base layer 1, namely, each annular protrusion (or ring) 21 being concentrically neighbored with each annular recess (or groove) 22.

As shown in FIG. 8, a plurality of square protrusions 21 and recesses 22 are alternately formed on the base layer 1, and all the protrusions 21 are parallelly arranged as linear rows or columns, with either rows or columns being aligned projectively.

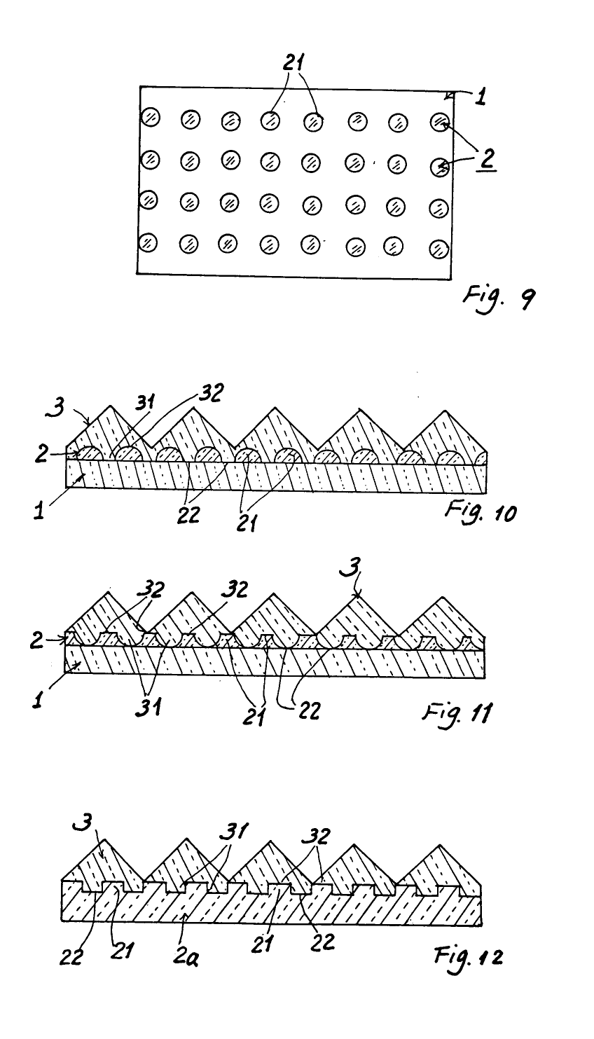

As shown in FIG. 9, the square protrusions 21 have been modified as circular, spherical or short-cylinder shapes.

The middle layer 2 is made of transparent materials, having a refractive index equal to or different from the refractive index of the base layer 1.

As shown in FIG. 10, the protrusions 21 of the middle pattern layer 2 have been modified to be a plurality of convex lens 21, each convex len (or convex portion) 21 being neighbored to each recess 22 which may also be formed as a flat portion.

As shown in FIG. 11, the recesses 22 of the middle pattern layer 2 have been modified to be a plurality of concave lens 22 each neighbored to each protrusion 21 generally formed as a π shape.

The convex lens or concave lens may help focus incident light into the prismatic layer 3 to have totally internal reflection or refraction within each prism of the upper prismatic layer 3 to enhance the brightness of the optical film of the present invention.

The upper prismatic layer 3 may be made of photo-curing or thermosetting (or heat-curing) resins, which may also be same to that provided for making the middle pattern layer 2. The upper layer 3 may be made of transparent materials, having a refractive index same to or different from that of the middle pattern layer 2.

The upper prismatic layer 3 includes a plurality of alternating root portions 31 and contracted portions 32 to be respectively engaged with the recesses 22 and protrusions 21 of the middle pattern layer 2.

Even though the shapes of the protrusion 21 or recess 22 of the middle layer 2 are not limited in the present invention, they are however preferably formed as arcuate, spherical or semi-spherical shapes, each having suitable curvature.

A process for making the multiple-layer optical film of the present invention comprises the steps of:
1. Forming or imprinting the middle pattern layer 2 having a plurality of alternating protrusions 21 and recesses 22 on the base layer 1; and
2. Forming or imprinting or laminating the upper prismatic layer 3 on the middle pattern layer 2 to allow each root portion 31 protruding downwardly from the upper prismatic layer 3 to be engaged with each recess 22 as recessed in the middle pattern layer 2, and to simultaneously engage each protrusion 21 of the middle pattern layer 2 with each contracted portion 32 as upwardly recessed in the upper prismatic layer 3.

The alternating corrugated structure formed by the related coupling parts, namely the root portions 31 with the recesses 22; and the contracted portions 32 with the protrusions 21, will form an interlocking structure, like a cross-linking structure, to firmly fasten or interlock the three layers 3, 2, 1 with one another to produce an optical film with dimensional stability or stiffness, durable for attacks by several environmental factors including the temperature fluctuations, humidity variations, thereby preventing warping, waving, buckling and Mura phenomena.

Before forming the middle pattern layer 2 on the base layer 1, the base layer 1 may be preliminarily performed with surface treatment. For instance, the upper surface of the base layer 1 may be coated with a prime coating, or performed with corona treatment or plasma treatment to increase the affinity or bonding in between the middle layer 2 (or upper layer 3) and the base layer 1. The middle pattern layer 2 as formed on the base layer 1 may include several methods such as imprinting or molding process. A photo-curing resin (including UV-curing resin) or thermosetting resin may be used to form the plurality of alternating protrusions 21 and recesses 22 in the middle layer 2 by molding or imprinting process. The photo-curing (or UV-curing) resin or thermosetting resin will be radiated by UV (ultra-violet) lamps or heated by a heater for curing or hardening the middle pattern layer 2 on the base layer 1.

When applying the photo-curing or thermo-setting resin of the upper prismatic layer 3 on the middle pattern layer 2, the resin may flow, fill, settle or drain from the upper layer 3 into the recesses 22 in the middle layer 2. After being radiated by UV lamps or heated by a heater, the resin will be cured or hardened to form the plurality of root portions 31 of the upper layer 3 each root portion 31 engaged with each recess 22 in the middle layer 2.

Simultaneously, each root portion 31 is neighboured or juxtapositoned with a contracted portion 32 which is recessed upwardly in a bottom portion of the upper layer 3 and engaged with each protrusion 21 of the middle layer 2.

So, the upper layer 3 has a plurality of alternating root portions 31 and contracted portions 32 to be laminated on the middle layer 2.

Therefore, a plurality of alternating protrusions and recesses; alternating convex portions and concave portions; or alternating ridges and grooves (or troughs) will be obtained in accordance with the present invention. Such alternating protrusions and recesses will form a strong interlocking mechanism or structure by firmly fastening, bonding, integrating or laminating the multiple layers of the optical film including the upper layer 3, the middle layer 2 and the base layer 1.

Therefore, the multiple layers of the optical film (or films) will be firmly bonded to prevent from dimensional instability, warping or other defects, especially when subjected to environmental fluctuations.

Meanwhile, the alternating protrusion and recess layer will become an optical diffusion layer or light concentrating layer for increasing the light uniformity or brightness of the optical film.

The alternating concave and convex structures, especially as shown in FIGS. 10˜11 of the present invention, may also serve as concave and convex lens for concentrating the incident light into the prisms of the upper prismatic layer 3, wherein the prisms of the upper layer 3 will help total internal reflection or diffraction within the prisms to prevent or reduce light loss through the prismatic layer 3.

Such alternating protrusions or recesses among the multiple layers will help the multiple layers to be stably firmly interlocked, thereby being difficult to be damaged or stripped and being helpful for prolonging the service life of the optical film.

As shown in FIG. 12, the base layer 1 is eliminated. The middle pattern layer 2 may now be modified as a supporting pattern layer 2a.

The supporting pattern layer 2a may be formed with a plurality of alternating protrusions 21 and recesses 22 on an upper portion of the supporting pattern layer 2a, each protrusion 21 engaged with each contracted portion 32 of the upper prismatic layer 3 and each recess 22 engaged with each root portion 31 of the upper layer 3. The supporting pattern layer 2a may be made of thermosetting resin preformed with the plurality of protrusions 21 and recesses 22 on (or in) the layer 2.

The imprinting process as used in the present invention may include: planography, letterpress, intaglio, silk screen printing, etc.

The present invention may be further modified without departing from the spirit and scope of the present invention. For instance, the shapes of the protrusions or recesses may be any geometrical shapes, not limited in the present invention.

I claim:

1. A multiple-layer optical film comprising:
a base layer;
a middle alternating protrusion and recess pattern layer having a plurality of alternating protrusions and recesses formed on said base layer; and
an upper prismatic layer having a plurality of alternating root portions and contracted portions, and formed or laminated on said middle alternating protrusion and recess pattern layer;
each said root portion protruding downwardly from said upper prismatic layer and engaged with each said recess in said middle pattern layer; and each said contracted portion recessed upwardly in a bottom portion of said upper prismatic layer and engaged with each said protrusion of said middle pattern layer;
whereby upon bonding of said upper prismatic layer with said middle pattern layer on said base layer, an interlocking multiple-layer optical film is formed.

2. An optical film according to claim 1, wherein said protrusions of said middle pattern layer are each formed as a linear strip, and said recesses each formed as a linear groove juxtapositioned to each said protrusion.

3. An optical film according to claim 1, wherein each said protrusion of said middle pattern layer is formed as a square protrusion.

4. An optical film according to claim 1, wherein each said protrusion of said middle pattern layer is formed as an annular protrusion.

5. An optical film according to claim 1, wherein each said protrusion of said middle pattern layer is formed as circular or cylindrical shape.

6. An optical film according to claim 1, wherein said protrusions of said middle pattern layer are formed as convex lens in between the upper prismatic layer and the base layer.

7. An optical film according to claim 1, wherein said recesses of said middle pattern layer are formed as concave lens in between the upper prismatic layer and the base layer.

8. A process for making multiple-layer optical film as set forth in claim 1 comprising the steps of:
A. Forming or imprinting the middle pattern layer made of photo-curing resin or thermosetting resin to have said plurality of alternating protrusions and recesses on said base layer; and
B. Forming or imprinting said upper prismatic layer by applying a photo-curing resin or thermosetting resin on said middle pattern layer above said base layer to allow the resin of the upper prismatic layer to fill into the recesses in said middle pattern layer to form a plurality of root portions protruding downwardly from said upper prismatic layer to engage or interlock each said root portion of said upper prismatic layer with each said recess in said middle pattern layer to obtain an interlocking multiple-layer optical film.

9. A process according to claim 8, wherein said base layer is preliminarily performed with surface treatment consisting of: prime coating, corona treatment, and plasma treatment.

10. A multiple-layer optical film comprising:
a supporting pattern layer having a plurality of alternating protrusions and recesses formed on an upper portion of said supporting pattern layer; and
an upper prismatic layer having a plurality of alternating root portions and contracted portions formed on said supporting pattern layer;
each said root portion of said upper prismatic layer engaged with each said recess in said supporting pattern layer and each said protrusion of said supporting pattern layer engaged with each said contracted portion of said upper prismatic layer to form an interlocking multiple-layer optical film.

11. A process for making multiple-layer optical film as set forth in claim 10 comprising the steps of:
A. Forming or imprinting said plurality of alternating protrusions and recesses on the upper portion of the supporting pattern layer made of thermosetting resin;
B. Forming said upper prismatic layer by applying a photo-curing resin or thermosetting resin on said supporting pattern layer to allow the resin of the upper prismatic layer to fill into the recesses in said supporting pattern layer to form a plurality of root portions protruding downwardly from said upper prismatic layer to engage each said root portion of said upper prismatic layer with each said recess in said supporting pattern layer to form the interlocking multiple-layer optical film.
